(19) United States
(12) Patent Application Publication
(10) Pub. No.: US 2014/0273692 A1
(43) Pub. Date: Sep. 18, 2014

(54) HIGH TACK REPOSITIONABLE ADHESIVES AND SUBSTRATES AND METHODS FOR THEIR MANUFACTURE

(71) Applicant: NCR CORPORATION, Duluth, GA (US)

(72) Inventors: Martha Patricia Wild, Duluth, GA (US); Zhengzhi Zhou, Suwanee, GA (US)

(73) Assignee: NCR CORPORATION, Duluth, GA (US)

(21) Appl. No.: 13/828,471

(22) Filed: Mar. 14, 2013

(51) Int. Cl. C09J 133/10; C09J 7/02

(52) U.S. Cl. CPC C09J 133/10; C09J 7/0207
USPC 442/151; 524/507; 428/355 AC; 428/354; 428/344

(57) ABSTRACT

High tack repositionable adhesive obtained by combining an acrylic copolymer permanent pressure sensitive adhesive with a hydrophobically modified ethoxylate urethane (HEUR) thickener. The adhesive provides repositionable substrates, such as thermal paper, with high tack. Methods for preparing the high tack repositionable adhesive are provided.

### FIELD OF THE INVENTION

This invention relates to a repositionable pressure sensitive adhesive comprising an acrylic copolymer adhesive and a hydrophobically modified ethoxylate urethane thickener that exhibits enhanced adhesion to substrates.

### BACKGROUND

Repositionable pressure-sensitive adhesives typically comprise tacky, elastomeric microspheres as described in the following patents:
U.S. Pat. No. 3,691,140, issued to Silver;
U.S. Pat. No. 3,857,731, issued to Merrill et al.;
U.S. Pat. No. 4,166,152, issued to Baker et al.;
U.S. Pat. Nos. 4,495,318 and 4,598,112, issued to Howard;
U.S. Pat. Nos. 4,988,567, 4994,322 and 5,053,436, issued to Delgado et al.;
U.S. Pat. No. 5,326,842, issued to Knudsen et al. and
U.S. RE37563, issued to Cooprider et al.

Repositionable adhesives are commonly used for temporary messaging, such as Post-it® brand notes, and usually have very low tack to prevent them from permanently adhering to surfaces. With such products, it is desirable for the adhesive to remove cleanly, without leaving a residue, while providing repositionable features. The problem with these repositionable pressure-sensitive adhesives is that they either have no adhesion at border line coat weight (thin coatings) or they lose their adhering properties during aging. In particular, conventional repositionable adhesives do not age well when applied to thermal paper and lose their adhesion after a couple of weeks. In addition, they can only be used a limited number of times before the adhesive wears off. As shown in the patents listed above, efforts have been made to increase the tackiness of the repositionable adhesives which contain elastomeric microspheres. However, high tack adhesives can adhere so well, that when removed from paper or cardboard it tends to rip the substrate. New formulations are desired.

### SUMMARY

The present invention provides a high tack, repositionable pressure sensitive adhesive through a unique formulation that comprises a permanent acrylic copolymer pressure sensitive adhesive and a hydrophobically modified ethoxylate urethane thickener. The thickener changes the chemistry of the acrylic copolymer pressure adhesive serving not only to increase viscosity, but also the coat weight and tackiness of the resulting pressure sensitive adhesive. A surprising feature of this adhesive mixture is that when applied on paper, it can be separated when folded on the adhesive side, although high in tack.

The repositionable substrates provided by this invention utilize the adhesive on various substrates including paper for printing, such as thermal paper and papers used in ink jet, offset, laser, litho and flexo printing processes. These repositionable substrates continue to adhere well to most surfaces at high tack, such as metal, uncoated paper, cardboard, plastic, silicone coated paper, etc., after being removed and applied repeatedly.

The methods for preparing these adhesives comprise blending of the permanent acrylic copolymer pressure sensitive adhesive and a hydrophobically modified ethoxylate urethane thickener, with or without added components, and letting them stand after mixing to build viscosity, coat weight and tack.

As used herein, the term “repositionable adhesive” refers to adhesives with the ability to be repeatedly adhered to and removed from a substrate without substantial loss of adhesion capability.

As used herein, the term “permanent adhesive” refers to adhesives with the ability to form a permanent bond either on initial contact with a substrate or by building adhesive strength over time.

It is contemplated that the acrylic copolymers suitable for use in preparing the repositionable adhesives of this invention comprise permanent acrylic copolymer pressure sensitive adhesives. Particularly suitable are freezer-grade pressure sensitive adhesives. This includes formulations with acrylic copolymers having a glass transition temperature below −10° C., more preferably below −25° C., even more preferably below −50° C., and most preferably below −70° C. Examples include the acrylic copolymers described in U.S. Pat. No. 5,049,608, issued to Medina and the commercially available freezer grade pressure sensitive adhesive, Covinax 258-00, available from Franklin Adhesives & Polymers of Columbus, Ohio. Covinax 258-00 is a surfactant (anionic) stabilized acrylic copolymer developed with an extremely low glass transition temperature of about −80° C.

The suitable acrylic copolymers comprise about 70% to 99.5% of a C₁-C₁₄ alkyl acrylate ester and/or C₁-C₁₄ alkyl(meth)acrylate ester and from 30% to 0.5% of an oil-insoluble/water soluble ionic monomer or polar monomer or maleic anhydride. These acrylic copolymers are tacky, elastomeric polymers which are solvent-insoluble but solvent-dispersible.

The suitable acrylic copolymers preferably have low glass transition temperatures consistent with freezer grade pressure sensitive adhesives used in bonding paper and other materials at temperatures below 0° C. Unless modified, these acrylic copolymers can provide adhesive coatings which, when dried, typically exhibit a dry coating weight in the range of 0.2 to about 2 grams per square foot.

The alkyl acrylate ester and/or alkyl methacrylate ester monomer portion of the acrylic copolymer may comprise one alkyl acrylate ester or alkyl methacrylate ester monomer or a mixture of two or more ester monomers. Similarly, the oil-insoluble/water soluble co-monomer portion of the acrylic copolymer microspheres may comprise maleic anhydride alone, an ionic monomer alone, a polar monomer alone, a mixture of two or more ionic monomers, a mixture of two or more polar monomers, or a mixture of maleic anhydride with one or more ionic monomers.

The alkyl acrylate ester/alkyl methacrylate ester portion of these acrylic copolymers preferably comprise as a major portion ester monomers which are oleophilic, water-emulsifiable, of restricted water-solubility, and which, as homopolymers, preferably have glass transition temperatures below about −10° C., more preferably below −25° C., even more preferably below −50° C., most preferably below −70° C. The alkyl group for these ester monomers typically contains 2 to about 14 carbon atoms, preferably 4 to about 14 carbon atoms.

Typical alkyl acrylate ester monomers which are suitable for the acrylic copolymer used in the present invention include ethyl acrylate, sec-butyl acrylate, n-butyl acrylate, 2-methylbutyl acrylate, isoamyl acrylate, 4-methyl-2-pentyl acrylate, isobornyl acrylate, 2-ethylhexyl acrylate, isooctyl acrylate, isononyl acrylate, isodecyl acrylate 2-ethoxyethyl acrylate, and combinations thereof.

Typical alkyl methacrylate ester monomers which are suitable for the acrylic copolymer microsphere pressure sensitive adhesives used in the present invention include t-butyl methacrylate, 2-ethylhexyl methacrylate, decyl methacrylate, isodecyl methacrylate, and combinations thereof.

Combinations of alkyl acrylate ester monomers and alkyl methacrylate ester monomers are also suitable.

Alkyl acrylate ester/alkyl methacrylate ester monomers with glass transition temperatures higher than −10° C. such as methylmethacrylate, methyl acrylate, ethyl acrylate, tert-butyl acrylate, and iso-bornyl acrylate, may also be used in conjunction with one of the above described alkyl acrylate ester monomers, provided the combination produces a copolymer or terpolymer generally having a glass transition temperature below about −10° C., preferably below −25° C., more preferably below −50° C., even more preferably below −70° C.

The oil-insoluble/water-soluble monomers typically have a solubility in an oil phase of less than 0.5% by weight.

Ionic monomers suitable for use in the acrylic copolymers include sodium methacrylate, ammonium acrylate, sodium acrylate, trimethylamine p-vinyl benzimide, 4,4,9-trimethyl-4-azonia-7-oxo-8-oxa-dec-9-ene-1-sulphonate, and N,N-dimethyl-N-(.beta.-methacryloxyethyl) ammonium propionate betaine.

Examples of polar monomers suitable for use in the acrylic copolymers of this invention include organic carboxylic acids and derivatives thereof comprising 3 to about 12 carbon atoms and having generally 1 to about 4 carboxylic acid moieties. Nonlimiting examples of such monomers include acrylic acids, methacrylic acids, itaconic acids, fumaric acid, crotonic acid, maleic acid, beta-carboxyethylacrylates, acrylamide, methacrylamide, N-vinyl pyrrolidone, N-vinyl caprolactam, 2-hydroxyethyl acrylate, and the like.

Examples of suitable acrylic copolymers include isooctyl acrylate/acrylic acid, preferably at a ratio of about 93/7 wt/wt.; 2-methyl butyl acrylate/acrylic acid at a ratio of about 90/10 wt/wt.; isooctyl acrylate/methyl acrylate/acrylic acid at a ratio of about 70/22.5/7.5 wt/wt.; and 2-methyl butyl acrylate/acrylamide at a ratio of about 96/4 wt/wt.

Examples of other suitable comonomers that do not fall within the above classes of “ionic” or “polar” but can be included in the acrylic copolymers are vinyl ester monomers which form homopolymers that have glass transition temperatures below about −10° C., such as vinyl 2-ethylhexanoate, vinyl caprate, vinyl laurate, vinyl pelargonate, vinyl hexanoate, vinyl propionate, vinyl decanoate, and vinyl actanoate. Vinyl monomers such as vinyl acetate and acrylonitrile which, as homopolymers, have glass transition temperatures higher than about −10° C., may be used provided the glass transition temperature of the resultant polymer is below about −10° C., preferably below −25° C., more preferably below −50° C., even more preferably below −70° C.

Other functional monomers suitable for use in the acrylic copolymer include N,N-dimethyl-aminoethyl(methyl)acrylate, N,N-dimethylaminopropyl-(meth)acrylate, t-butylaminoethyl(methyl)acrylate, N,N-diethylaminoacrylate hydroxyethyl(meth)acrylate, glycerol mono(meth)acrylate, 4-hydroxybutyl(meth)acrylate, acrylate terminated poly(ethylene oxide), methacrylate terminated poly(ethylene oxide), methoxy poly(ethylene oxide) methacrylate, butoxy poly(ethylene oxide) methacrylate, acrylate terminated poly(ethylene glycol), methacrylate terminated poly(ethylene glycol), methoxy poly(ethylene glycol) methacrylate, butoxy poly(ethylene glycol) methacrylate, N-vinyl pyrrolidone, N-vinyl caprolactom acrylamide or N,N-dimethyl acrylamide, (meth)acrylonitrile, furfuryl(meth)acrylate and tetrahydrofurfuryl(meth)acrylate, 2-vinyl pyridine, 4-vinyl pyridine, and mixtures thereof.

The acrylic copolymer used in the present invention can be prepared in an emulsion by conventional suspension polymerization processes using conventional free-radical polymerization initiators, conditions (temperature, agitation, nitrogen purge), and emulsifiers/surfactants to stabilize the emulsion.

Suitable surfactants include anionic and nonionic surfactants. Suitable anionic surfactants include sulfonic acid salts, such as di-alkyl sulfosuccinates, alcohol sulfates, such as sodium lauryl sulfate, alkylbenzene sulfonates, phosphoric acid esters, and carboxylic acid salts, such as sodium stearate.

Suitable nonionic surfactants include polyoxyethylenated alkylphenols, alcohol ethoxylates, alkylphenol ethoxylates, and alkanolamides. U.S. Pat. No. 5,049,608 (Medina) describes poly(ethyleneoxy)ethanols as a suitable nonionic surfactants for acrylic polymers with low glass transition temperature values. Examples include poly(ethyleneoxy)ethanol surfactants containing at least 70 ethylene oxide units such as C₇ to C₁₈ alkylphenoxypoly(ethyleneoxy) ethanol. Nonionic surfactants specified in U.S. Pat. No. 5,049,608 (Medina) include octylphenoxypoly(ethyleneoxy)ethanol and nonylphenoxypoly(ethyleneoxy)ethanol.

The acrylic copolymer can be prepared with polymerization/molecular weight modifiers, such as conventional chain transfer agents and crosslinking agents used in conventional amounts. By using crosslinking agents and/or chain transfer agents, the performance of the resulting adhesive (tack, peel adhesion, shear adhesion, adhesion to specific substrates) can be tailored to a given application. Examples of suitable crosslinking agents include those activated by heat, such as multifunctional aziridines and peroxides (benzoyl peroxide) which generate free radicals; those activated by ultraviolet light, such as triazines, benzophenones and 4-acryloxybenzophenones; and diisocyanates. Preferably, less than 0.5 wt % crosslinker, based on the weight of the acrylic copolymer, is used.

In a one-step process, both the alkyl acrylate ester/alkyl methacrylate ester monomer and oil-insoluble/water soluble comonomer (ionic monomer, polar monomer and/or maleic anhydride), are present together in the suspension at the initiation of polymerization. In a two-step process, the oil-insoluble/water soluble comonomer (ionic monomer, polar monomer and/or maleic anhydride) is added after polymerization of the alkyl acrylate ester/alkyl methacrylate ester has started.

The acrylic copolymer may be utilized immediately following polymerization. The acrylic copolymer will form suspensions in most common solvents. Typical useful solvents are ethyl acetate, tetrahydrofuran, heptane, 2-butanone and other ketones, benzene, cyclohexane, esters, isopropanol, and higher alcohols. Alternatively, additives may be introduced to the acrylic polymer preparing the pressure sensitive adhesive of the present invention to enhance particular properties.

Optionally, a plasticizer can be added to the acrylic copolymer before preparing the pressure sensitive adhesive of the present invention to enhance the fluidity. Suitable plasticizers include those described in U.S. Pat. No. 6,054,213, issued to Peacock. When used, the plasticizers are preferably added in small amounts of from 2-10 parts by weight of the acrylic copolymer. The plasticizer may be added at any time either before or after formation of the acrylic copolymer. It is preferable that the plasticizer be miscible with the acrylic copolymer and/or form a stable emulsion along with the acrylic copolymer.

Various conventional organic plasticizers can be used with acrylic copolymers. Suitable plasticizers include polyethylene oxides, such as polyoxyethylene aryl ether (commercially available from I.C.I. Americas under the trade name Pycal® 94), and polyoxypropylene aryl ether (commercially available from Rhone-Poulenc under the trade name Alkapol SQR-490); adipic acid esters, such as diethyladipate (commercially available from Monsanto under the trade name Santicizer®97), di(2-ethylhexyl) adipate (commercially available from Monsanto) and dibutoxyethoxyethyl adipate (commercially available from Sartomer under the trade name Sartomer 650 Wareflex); phosphoric acid esters, such as ethylhexyl diphenyl phosphate (commercially available from Monsanto under the trade name Santicizer®141), t-butylphenyl diphenyl phosphate (commercially available from Monsanto under the trade name Santicizer®154), 2-ethylhexyl phosphate, and tricresyl phosphate, sulfonamides, such as toluenesulfonamide (commercially available from Akzo Nobel under the trade name Ketjenflex 8), benzoic acid esters, such as dipropylene glycol dibenzoate and polyethylene glycol dibenzoate (both commercially available from Velsicol under the trade names Benzoflex 9-88 and Benzoflex P-200), and formic acid esters, such as dibutoxyethoxyethyl formal (commercially available from Sartomer under the trade name Sartomer 660 (Cryoflex)). Another useful plasticizers is dioctyl phthalate.

Optionally, a tackifier can be added to the acrylic copolymer before preparing the pressure sensitive adhesive of the present invention to enhance tack. A suitable example is Nirez®2091, a terpene phenolic resin commercially available from Arizona Chemical. Other suitable tackifiers include those based on t-butyl styrene and hydrogenated rosin esters commercially available from such companies as Hercules, Inc. under the trade names of Foral®, Regalrez®, and Pentalyn®.

Although not required, fillers (clay) or colorants (TiO₂ or carbon black) may optionally be used as additives to impart opacity or color to the adhesive. Other optional adjuvants include polymer stabilizers (heat stabilizers, antioxidants, light inhibitors). Typically, the properties of the acrylic copolymers are sufficiently stable over a wide variety of conditions that heat stabilizers, antioxidants, light inhibitors, and other polymer stabilizers/protectants are not required.

The second component of the high tack, repositionable pressure sensitive adhesive of this invention is a non-ionic urethane rheology modifier: more specifically, a hydrophobically modified ethylene oxide urethane rheology (HEUR) thickener.

The HEUR thickeners used in this invention comprise urethane polymers chains with a molecular weight typically of from about 10,000 to 200,000, which have low molecular weight hydrophobic groups at the terminal ends. The hydrophobic groups typically contain a total of at least 20 carbon atoms and are linked through hydrophilic polyethylene oxide segments with a molecular weight typically of at least about 1500. The HEUR thickeners can be prepared by reacting at least one water soluble polyether polyol (alkoxylated polyol), at least one water insoluble organic polyisocyanate, at least one monofunctional hydrophobic organic compound, and at least one polyhydric alcohol/polyhydric alcohol ether(polyalkylene glycol). Methods for preparing HEUR thickeners are described in detail in U.S. Pat. Nos. 4,079,028, 4,155,892, 4,426,485 and 6,602,948 and U.S. Published Application No. 2012/0322936, which are incorporated herein by reference.

Preferred HEURs include those sold by Dow Chemical under the trade name ACRYSOL™ SCT-275.

Other suitable HEURS are those sold by Dow Chemical under the trade names ACRYSOL™ 60ER, ACRYSOL™ DR300, ACRYSOL™ RM-12W, ACRYSOL™ RM-2020, and ACRYSOL™ RM-3000; those sold by Akzo Nobel-Cellulosic Specialties under the trade names BERMODOL PUR 2102, BERMODOL PUR 2110, and BERMODOL PUR 2130, those sold by BASF under the trade names COLLACRAL PU 70 and COLLACRAL PU 80; those sold by BASF (Ciba) under the trade names RHEOVIS PU10 and RHEOVIS PU 20; those sold by BASF (Cognis) under the trade names DSX 1514, DSX 1516, DSX 1550, DSX 1575, and DSX 3000; those sold by Elemntis under the trade names NUVIS FX 1010, NUVIS FX 1025, NUVIS FX 1035, NUVIS FX 1050, and NUVIS FX 1070, and those sold by King Industries under the trade names K-STAY 720, K-STAY 730, K-STAY 731, and K-STAY 740.

The HEUR thickener is added to the acrylic copolymer emulsion and blended therein using conventional equipment for introducing additives or adjuvants to a pressure sensitive adhesive such as that of Ross Mixing Inc., Port St. Lucie, Fla. The amount of HEUR thickener added is preferably consistent with the conventional amounts used to thicken pressure sensitive adhesives with conventional thickeners. Amounts conventionally used to target a viscosity of 1800 cP in an acrylic copolymer pressure sensitive adhesive are suitable. Preferably less than about 5 wt % HEUR thickener is added to the acrylic polymer, based on the total weight of the acrylic polymer. It is contemplated the suitable amounts of HEUR thickener added to the acrylic polymer can range from about 0.1% to 5 wt % (based on the total weight of resulting solids in the mixture). Preferably, HEUR thickener is added to the acrylic polymer in amounts of about 1%, 1.25%, 1.5%, 1.75%, 2.0%, 2.25%, 2.5%, 2.75%, 3.0%, 3.25%, 3.5%, 3.75%, 4.0%, 4.25%, 4.5%, or 4.75%. Adding amounts within the range of about 2-3 wt % HEUR thickener (based on the total weight of resulting solids in the mixture) are expected to be more commonly preferred.

Once the acrylic copolymer and HEUR thickener are uniformly mixed, the viscosity of the mixture is allowed to build, preferably by allowing the mixture to stand. It is contemplated the viscosity can increase 2-25 times once the two components are completely mixed and allowed to stand. The tackiness of the mixture also builds. It is contemplated the tackiness can more than double, for example increase by a factor of 2.6, once the two components are completely mixed and allowed to stand.

The mixture exhibits properties consistent with repositionable adhesives, adhering well to most surfaces after being removed multiple times.

Once the viscosity has stabilized, the mixture can be processed by conventional means to be used as a pressure sensitive adhesive. This includes coating on various substrates such as paper, including papers for printing (thermal paper, papers for ink jet printing, offset printing, lithographic printing, flexographic printing and laser printing) as well as plastic films (vinyl, plasticized polyvinylchloride, polyesters, polyolefins, polyacrylates, polyurethanes, ethylene vinyl acetates, perfluoropolymers, polycarbonates), silicone coated paper, cellulose acetate, ethyl cellulose, foils, woven and nonwoven synthetic and/or natural sheets and fabrics, metal, metallized polymeric film (retro-reflective sheeting), and ceramic sheet material.

Conventional additives and adjuvants for repositionable adhesives can be added to the high tack, pressure sensitive adhesives of this invention either before or after the viscosity build. Common additives and adjuvants include fillers (clay) and colorants (TiO₂ or carbon black) and polymer stabilizers.

Through the use of the acrylic copolymer pressure sensitive adhesives described above, the present invention provides repositionable adhesive products such as repositionable paper products (notes and labels), repositionable tape and tape flags, easel sheets, repositionable glue stick and the like, but may also include other non-repositionable industrial, commercial, and medical adhesive products.

The present invention is further illustrated by the following examples, but the particular materials and amounts thereof recited in these examples, as well as other conditions and details, should not be construed to unduly limit this invention. The following examples are illustrative in nature and are not intended to limit the invention in any way.

### EXAMPLE

To 500 g of a freezer grade acrylic copolymer pressure sensitive adhesive (Covinax 258-00, 300 cP and 59 wt % solids, sold by Franklin Adhesives and Polymers), a HEUR thickener sold by DOW under the trade name ACRYSOL™ SCT-275, is added in an amount less than 5 wt %, based on the total weight of solids in Covinax 258-00. The two components are mixed in a rotary mixer to thicken the Covinax 258-00 adhesive and increase its viscosity to a target 1800 cP. Once the target viscosity is reached, the mixing is stopped and the mixture is allowed to rest while viscosity increases to about 4500 cP. or above (5500 cP.).

The peel force (tackiness) of a freezer grade acrylic copolymer pressure sensitive adhesive (Covinax 258-00, 300 cP and 59 wt % solids, sold by Franklin Adhesives and Polymers), when measured by a conventional test, is about 0.111b.

The peel force (tackiness) of a two component mixture of a freezer grade acrylic copolymer pressure sensitive adhesive Covinax 258-00 and a HEUR thickener sold by DOW under the trade name ACRYSOL™ SCT-275, when measured by the same conventional test, is about 0.29 lbs. This peel force is more than double (2.6 times) the peel force of the freezer grade acrylic copolymer pressure sensitive adhesive without thickener.

The adhesive/thickener mixture is then applied on paper to form repositionable substrates that adhere well to metal, uncoated paper, cardboard, plastic, and silicone coated paper after being applied and removed over ten times. The paper substrates can be separated when folded on the adhesive side.

The description of the foregoing embodiment of the invention has been presented for purposes of illustration and description. It is not intended to be exhaustive or to limit the invention to the precise form disclosed, and obviously many modifications and variations are possible in light of the above teachings. The embodiments were chosen and described in order to explain the principles of the invention and its practical application to enable thereby others skilled in the art to utilize the invention in various embodiments and with various modifications as are suited to the particular use contemplated. All references cited herein are hereby incorporated by reference.

What is claimed is:

1. A high tack repositionable pressure-sensitive adhesive comprising a mixture which comprises:
A. 99.9-95 wt % of a permanent acrylic copolymer pressure sensitive adhesive having a glass transition temperature of less than −10° C. comprising about 70% to 99.5% of a C₁-C₁₄ alkyl acrylate ester monomers and/or C₁-C₁₄ alkyl(meth)acrylate ester monomers and from 30% to 0.5% of oil-insoluble/water soluble ionic monomers or polar monomers or maleic anhydride, and
B. 0.1-5.0 wt % of a hydrophobically modified ethoxylate urethane thickener comprising urethane polymers chains with hydrophobic groups at the terminal ends which contain a total of at least 20 carbon atoms and are linked through hydrophilic polyethylene oxide segments with a molecular weight of at least about 1500.

2. A high tack repositionable pressure-sensitive adhesive as in claim 1 wherein the acrylic copolymer has a glass transition temperature of less than −25° C. and comprises 70% to 99.5% C₄-C₁₄ alkyl acrylate ester monomers and/or C₄-C₁₄ alkyl(meth)acrylate ester monomers and 30% to 0.5% polar monomers.

3. A high tack repositionable pressure-sensitive adhesive as in claim 2 wherein the acrylic copolymer has a glass transition temperature of less than −50° C. and comprises alkyl acrylate ester monomers and/or C₄-C₁₄ alkyl(meth)acrylate ester monomers selected from the group consisting of sec-butyl acrylate, n-butyl acrylate, 2-methylbutyl acrylate, isoamyl acrylate, 4-methyl-2-pentyl acrylate, isobornyl acrylate, 2-ethylhexyl acrylate, isooctyl acrylate, isononyl acrylate, isodecyl acrylate 2-ethoxyethyl acrylate, and combinations thereof and the polar monomers comprise organic carboxylic acids and derivatives thereof comprising 3 to about 12 carbon atoms and 1 to about 4 carboxylic acid moieties.

4. A high tack repositionable pressure-sensitive adhesive as in claim 1 wherein the acrylic copolymer has a glass transition temperature of less than −70° C. and the polar monomer is selected from acrylic acids, methacrylic acids, itaconic acids, fumaric acid, crotonic acid, maleic acid, beta.-carboxyethylacrylates, acrylamide, methacrylamide, N-vinyl pyrrolidone, N-vinyl caprolactam, and 2-hydroxyethyl acrylate.

5. A high tack repositionable pressure-sensitive adhesive as in claim 1 wherein the ionic monomers are selected from sodium methacrylate, ammonium acrylate, sodium acrylate, trimethylamine p-vinyl benzimide, 4,4,9-trimethyl-4-azonia-7-oxo-8-oxa-dec-9-ene-1-sulphonate, and N,N-dimethyl-N-(.beta.-methacryloxyethyl)ammonium propionate betaine.

6. A high tack repositionable pressure-sensitive adhesive as in claim 1 wherein the amount hydrophobically modified ethoxylate urethane thickener therein is 2-3 wt %, based on the weight of the total solids therein.

7. A high tack repositionable pressure-sensitive adhesive comprising a mixture which comprises:
A. 99.9-95 wt. % of a permanent acrylic copolymer pressure sensitive adhesive having a glass transition temperature of less than −50° C. comprising about 70% to 99.5% alkyl acrylate ester monomers selected from the group consisting of isooctyl acrylate and 2-methyl butyl acrylate and from 30% to 0.5% of oil-insoluble/water soluble ionic monomers or polar monomers or maleic anhydride, and
B. 0.1-5.0 wt. % of a hydrophobically modified ethoxylate urethane thickener comprising urethane polymers chains with hydrophobic groups at the terminal ends which contain a total of at least 20 carbon atoms and are linked through hydrophilic polyethylene oxide segments with a molecular weight of at least about 1500,
in a weight ratio of 100:1-4 of component A to component B.

8. A high tack repositionable pressure-sensitive adhesive as in claim 1 wherein the permanent acrylic copolymer is derived from an emulsion stabilized with a surfactant.

9. A high tack repositionable pressure-sensitive adhesive as in claim 1 which additionally comprises tackifiers, plasticizers, cross-linking agents, or chain transfer agents.

10. A high tack repositionable pressure-sensitive adhesive as in claim 1 having a viscosity value which is 2-25 times that of the permanent acrylic copolymer pressure sensitive adhesive.

11. A repositionable substrate which comprises a high tack repositionable pressure-sensitive adhesive of claim 1.

12. A repositionable substrate as in claim 11, wherein the substrate is selected from the group consisting of
A. papers, including papers for printing (thermal paper, papers for ink jet printing, offset printing, lithographic printing, flexographic printing, and laser printing);
B. plastic films (vinyl, plasticized polyvinylchloride, polyesters, polyolefins, polyacrylates, polyurethanes, ethylene vinyl acetates, perfluoropolymers, and polycarbonates);
C. silicone coated papers;
D. cellulose acetate and ethyl cellulose sheets;
E. foils;
F. woven and nonwoven synthetic and/or natural sheets and fabrics;
G. metals;
H. metallized polymeric film (retro-reflective sheeting); and
I. ceramic sheet materials.

13. A repositionable substrate of claim 11 with values for adhesive strength/tack twice that of the acrylic copolymer without added hydrophobically modified ethoxylate urethane thickener.

14. A repositionable substrate of claim 11 which is selected from paper products, repositionable tape and tape flags, easel sheets, and repositionable glue stick.

15. A repositionable pressure-sensitive adhesive according to claim 1 wherein said acrylic copolymer comprises isooctyl acrylate and acrylic acid as the polar monomer.

16. A process for preparing a repositionable pressure-sensitive adhesive comprising:
A. stirring or agitating the following to obtain a uniform mixture,
a. 99.9-95 wt. % of a permanent acrylic copolymer pressure sensitive adhesive having a glass transition temperature of less than −10° C. comprising about 70% to 99.5% of a C₁-C₁₄ alkyl acrylate ester monomers and/or C₁-C₁₄ alkyl(meth)acrylate ester monomers and from 30% to 0.5% of oil-insoluble/water soluble ionic monomers or polar monomers or maleic anhydride, and
b. 0.1-5.0 wt % of a hydrophobically modified ethoxylate urethane thickener comprising urethane polymers chains with hydrophobic groups at the terminal ends which contain a total of at least 20 carbon atoms and are linked through hydrophilic polyethylene oxide segments with a molecular weight of at least about 1500;
B. terminating step A. and letting the mixture stand until the viscosity builds to at least double in magnitude.

17. A process for preparing a repositionable pressure-sensitive adhesive as in claim 16 wherein the mixture stands until the viscosity builds to 2-25 times the viscosity of the permanent acrylic copolymer prior to forming the mixture of step A.

18. A process for preparing a repositionable pressure-sensitive adhesive as in claim 16 wherein the mixture stands until values for adhesive strength/tack, as measured by peel strength, at least double.

19. A process for preparing a repositionable pressure-sensitive adhesive as in claim 16 which comprises the additional step of applying the mixture to a substrate following step B.
